(19) United States
(12) Patent Application Publication
(10) Pub. No.: US 2025/0118317 A1
(43) Pub. Date: Apr. 10, 2025

(54) SPEECH MODIFICATION ASSISTANCE APPARATUS, SPEECH MODIFICATION ASSISTANCE METHOD, SPEECH MODIFICATION ASSISTANCE COMPUTER PROGRAM PRODUCT, AND SPEECH MODIFICATION ASSISTANCE SYSTEM

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Yoshinori KURATA, Moriya Ibaraki (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/983,871

(22) Filed: Dec. 17, 2024

(30) Foreign Application Priority Data
Jul. 26, 2022 (JP) 2022-118791

(51) Int. Cl. G10L 21/013; G10L 13/033; G10L 13/08

(52) U.S. Cl. CPC G10L 21/013; G10L 13/0335; G10L 13/08

(57) ABSTRACT

A speech modification assistance apparatus (10) includes one or more hardware processors configured to function as a first reception unit (22A), a display control unit (21), and a second reception unit (22B). The first reception unit (22A) receives selection of target recorded speech data, which is basic recorded speech data (70) to be processed, from among one or more pieces of basic recorded speech data (70) that are recorded. The display control unit (21) converts the target recorded speech data into a basic character string and displays the basic character string. The second reception unit (22B) receives designation of a change target character string to be changed in the displayed basic character string. The generation control unit (24) generates modified speech data corresponding to the target recorded speech data and the change target character string.

### CROSS-REFERENCE TO RELATED APPLICATIONS

This application is a continuation of PCT International Application No. PCT/JP2023/026600 filed on Jul. 20, 2023 which claims the benefit of priority from Japanese Patent Application No. 2022-118791, filed on Jul. 26, 2022, the entire contents of which are incorporated herein by reference.

### FIELD

Embodiments described herein relate generally to a speech modification assistance apparatus, a speech modification assistance method, a speech modification assistance computer program product, and a speech modification assistance system.

### BACKGROUND

As a technology related to modification of speech data, a technology for synthesizing recorded speech data and synthesized speech data is disclosed. For example, a related art discloses a technology of automatically extracting a partial character string using recorded speech and a partial character string using synthesized speech from an input character string, and synthesizing the recorded speech and the synthesized speech by using an automatic extraction result.

However, in the related art, modified speech data obtained by modifying speech data using automatic extraction and automatic synthesis without intervention of an operation instruction from a user is generated. As such, with the related art, it is difficult to assist in easy adjustment by the user for modification of recorded speech data.

### BRIEF DESCRIPTION OF THE DRAWINGS

FIG. 1 is a diagram illustrating a speech modification assistance system;

FIG. 2A is a schematic view of a modification assistance screen;

FIG. 2B is a schematic view of the modification assistance screen;

FIG. 2C is a schematic view of the modification assistance screen;

FIG. 2D is a schematic view of the modification assistance screen;

FIG. 2E is a schematic view of the modification assistance screen;

FIG. 2F is an explanatory diagram of an example of generation of modified speech data;

FIG. 2G is a schematic view of a setting change screen;

FIG. 2H is a schematic view of a detailed edit screen;

FIG. 3 is a flowchart illustrating a flow of information processing executed by a speech modification assistance apparatus;

FIG. 4 is a flowchart illustrating a flow of information processing executed by an information processing apparatus; and

FIG. 5 is a hardware configuration diagram.

### DETAILED DESCRIPTION

A speech modification assistance apparatus according to an embodiment includes one or more hardware processors configured to function as a first reception unit, a display control unit, a second reception unit, and a generation control unit. The first reception unit is configured to receive selection of target recorded speech data, which is basic recorded speech data to be processed, from among one or more pieces of basic recorded speech data that are recorded. The display control unit is configured to convert the target recorded speech data into a basic character string and display the basic character string. The second reception unit is configured to receive designation of a change target character string to be changed in the displayed basic character string. The generation control unit is configured to generate modified speech data corresponding to the target recorded speech data and the change target character string.

An object of the present disclosure is to provide a speech modification assistance apparatus, a speech modification assistance method, a speech modification assistance computer program product, and a speech modification assistance system that can assist in easy adjustment by a user for processing of recorded speech data.

Hereinafter, exemplary embodiments of a speech modification assistance apparatus, a speech modification assistance method, a speech modification assistance computer program product, and a speech modification assistance system will be described in detail with reference to the accompanying drawings.

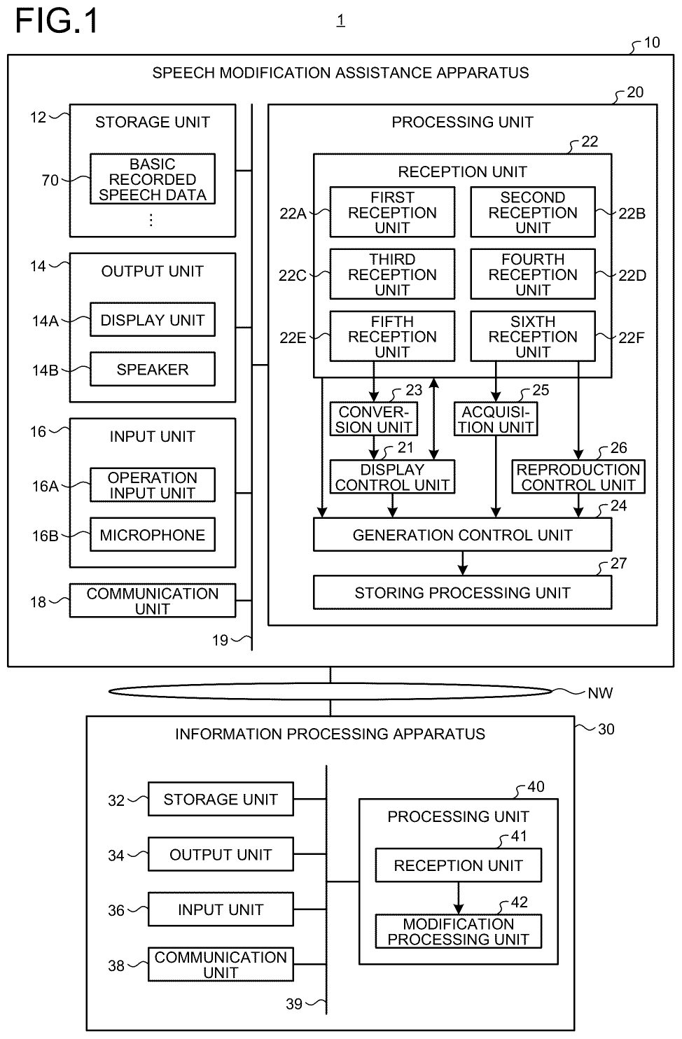

FIG. 1 is a diagram illustrating an example of a speech modification assistance system 1 according to the present embodiment.

The speech modification assistance system 1 includes a speech modification assistance apparatus 10 and an information processing apparatus 30.

The speech modification assistance apparatus 10 and the information processing apparatus 30 are configured to be able to exchange data via a network NW or the like. The speech modification assistance apparatus 10 and the information processing apparatus 30 may have any configuration as long as various data generated by the speech modification assistance apparatus 10 can be used by the information processing apparatus 30. Therefore, the speech modification assistance apparatus 10 and the information processing apparatus 30 may be configured to be able to exchange data via various storage media such as a universal serial bus (USB) memory.

The speech modification assistance apparatus 10 is an information processing apparatus for assisting in modification of recorded speech data.

The speech modification assistance apparatus 10 includes a storage unit 12, an output unit 14, an input unit 16, a communication unit 18, and a processing unit 20. The storage unit 12, the output unit 14, the input unit 16, the communication unit 18, and the processing unit 20 are communicably connected via a bus 19.

The storage unit 12 stores various data. The storage unit 12 is, for example, a random access memory (RAM), a semiconductor memory element such as a flash memory, a hard disk, an optical disk, or the like. The storage unit 12 may be a storage device provided outside the speech modification assistance apparatus 10. Furthermore, the storage unit 12 may be a storage medium. Specifically, the storage medium may store or temporarily store a program or various types of information downloaded via a local area network (LAN), the Internet, or the like. Furthermore, the storage unit 12 may be implemented by a plurality of storage media.

In the present embodiment, the storage unit 12 stores one or more pieces of basic recorded speech data 70 in advance.

The basic recorded speech data 70 is recorded speech data obtained by recording a speech uttered by a user. Specifically, the basic recorded speech data 70 is recorded speech data that is recorded in advance and can be provided as a processing target option in the speech modification assistance system 1 among the pieces of recorded speech data.

For example, the user utters a line included in a script or the like, which is a base of a performance, in a speech corresponding to a scene where the line is to be uttered or the like. The line is a word uttered by an utterer who appears in a play or a creation to be performed. The utterer is the user who utters the line.

For example, the user utters the line while adjusting acoustic feature amounts such as prosody and accent. The prosody includes at least one of intonation, pitch, stress, duration, and rhythm. The accent includes at least one of a pitch accent and a stress accent.

In the speech modification assistance apparatus 10, the speech uttered by the user is collected by a microphone 16B and stored in advance in the storage unit 12 as the basic recorded speech data 70.

In the present embodiment, a form for which the basic recorded speech data 70 is recorded speech data recorded by one utterance of the line by the user will be described as an example. However, the basic recorded speech data 70 is not limited to the recorded speech data of the line uttered by the user. For example, the basic recorded speech data 70 may be recorded speech data obtained by recording a speech uttered by the user in daily conversation or the like. Furthermore, the speech modification assistance apparatus 10 may store recorded speech data recorded by another information processing apparatus in the storage unit 12 in advance as the basic recorded speech data 70.

The output unit 14 is an output device for outputting various types of information. In the present embodiment, the output unit 14 includes a display unit 14A and a speaker 14B. The display unit 14A displays various types of information. The display unit 14A is, for example, a display such as a liquid crystal display (LCD) or an organic electro-luminescence (EL), a projection device, or the like. The speaker 14B outputs a speech.

The input unit 16 is an input device for receiving various instructions from the user. In the present embodiment, the input unit 16 includes an operation input unit 16A and the microphone 16B. The operation input unit 16A is an input device for receiving an operation instruction from the user. The operation input unit 16A is, for example, a pointing device such as a digital pen, a mouse, or a trackball, or an input device such as a keyboard. The microphone 16B is an input device for inputting a speech. The display unit 14A and the microphone 16B may be an integrally configured touch panel.

The communication unit 18 communicates with an external information processing apparatus via the network NW. In the present embodiment, the communication unit 18 communicates with the information processing apparatus 30 via the network NW.

The processing unit 20 executes various types of information processing. The processing unit 20 includes a display control unit 21, a reception unit 22, a conversion unit 23, a generation control unit 24, an acquisition unit 25, a reproduction control unit 26, and a storing processing unit 27. The reception unit 22 includes a first reception unit 22A, a second reception unit 22B, a third reception unit 22C, a fourth reception unit 22D, a fifth reception unit 22E, and a sixth reception unit 22F.

The display control unit 21, the reception unit 22, the first reception unit 22A, the second reception unit 22B, the third reception unit 22C, the fourth reception unit 22D, the fifth reception unit 22E, the sixth reception unit 22F, the conversion unit 23, the generation control unit 24, the acquisition unit 25, the reproduction control unit 26, and the storing processing unit 27 are implemented by, for example, one or more processors. For example, each of the above units may be implemented by causing a processor such as a central processing unit (CPU) to execute a program, that is, by software. Each of the above units may be implemented by a processor such as a dedicated integrated circuit (IC), that is, hardware. Each of the above units may be implemented by using software and hardware in combination. In the case of using a plurality of processors, each processor may implement one of the respective units, or may implement two or more of the respective units.

At least one of the above units may be implemented on a cloud server that executes processing on a cloud.

The display control unit 21 displays various images on the display unit 14A.

The reception unit 22 receives, from the input unit 16, an operation instruction from the user and recorded speech data of an uttered speech of the user. The reception unit 22 receives, from the operation input unit 16A, information indicating the operation instruction from the user. Furthermore, the reception unit 22 receives the recorded speech data of the uttered speech of the user from the microphone 16B.

In the present embodiment, the reception unit 22 includes the first reception unit 22A, the second reception unit 22B, the third reception unit 22C, the fourth reception unit 22D, the fifth reception unit 22E, and the sixth reception unit 22F.

The first reception unit 22A receives selection of target recorded speech data from one or more pieces of basic recorded speech data 70 that are recorded. The target recorded speech data means the basic recorded speech data 70 selected by the user as a processing target among the pieces of basic recorded speech data 70 recorded in advance. The processing target means a modification target.

In the present embodiment, the first reception unit 22A receives selection of the target recorded speech data via a modification assistance screen displayed on the display unit 14A by the display control unit 21.

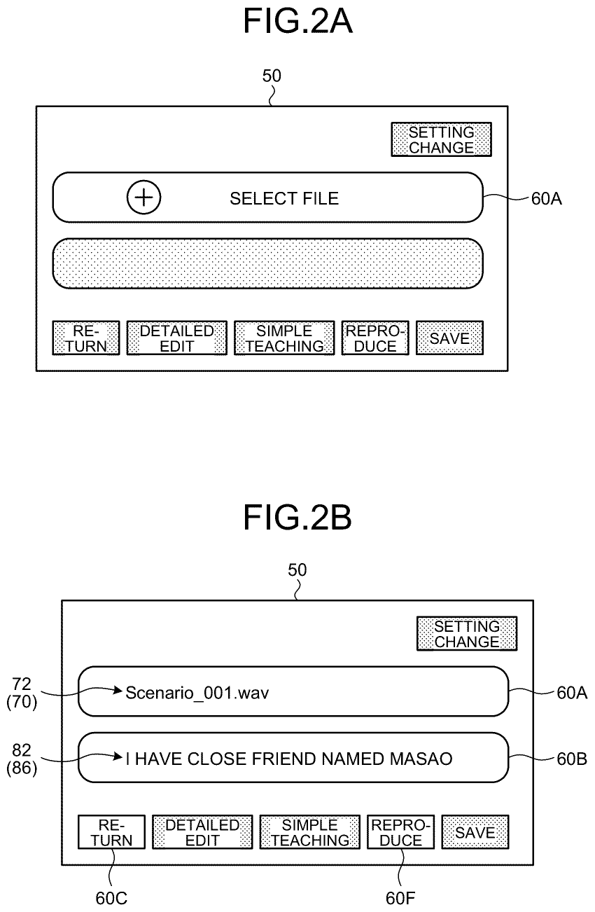

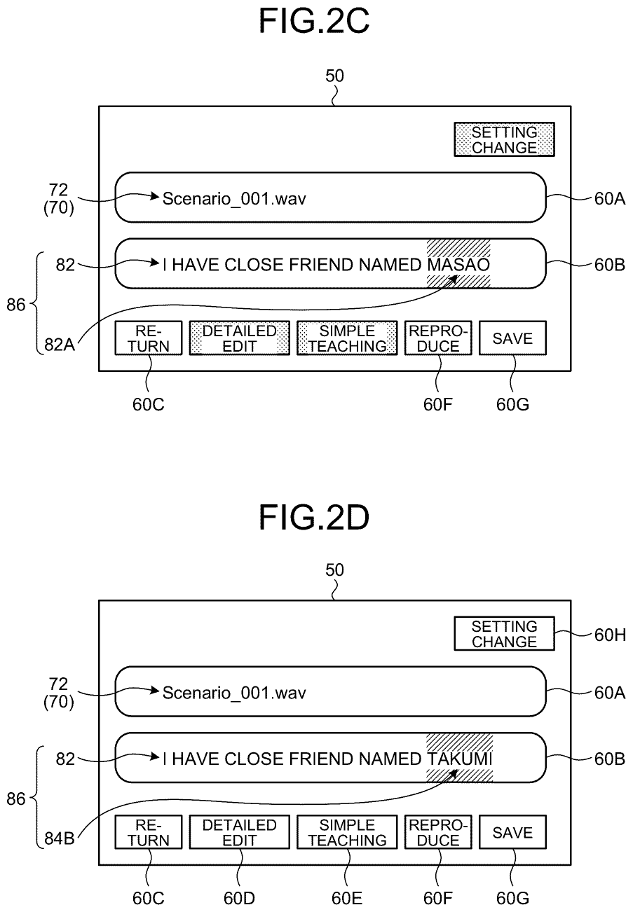

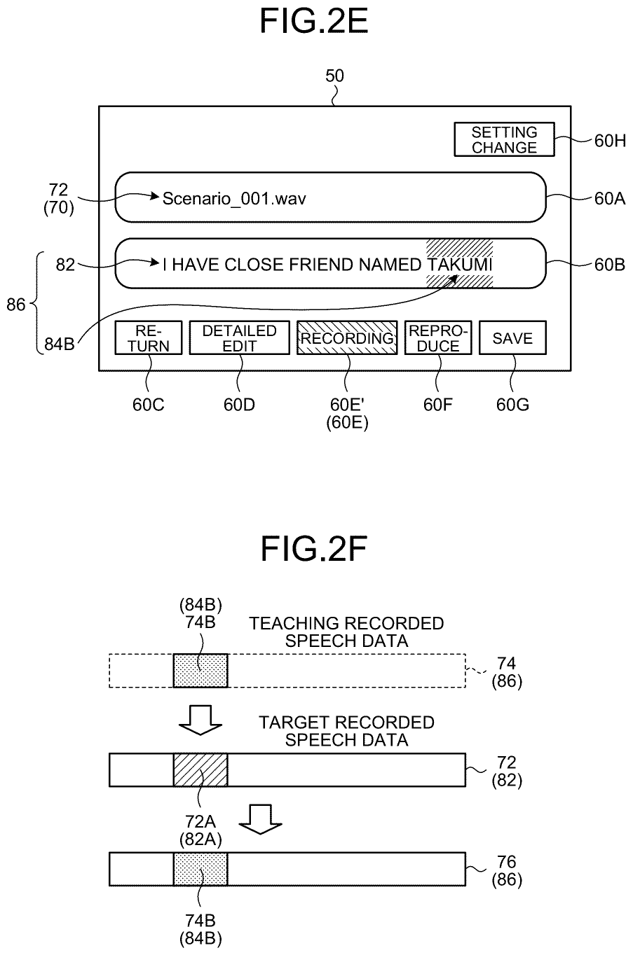

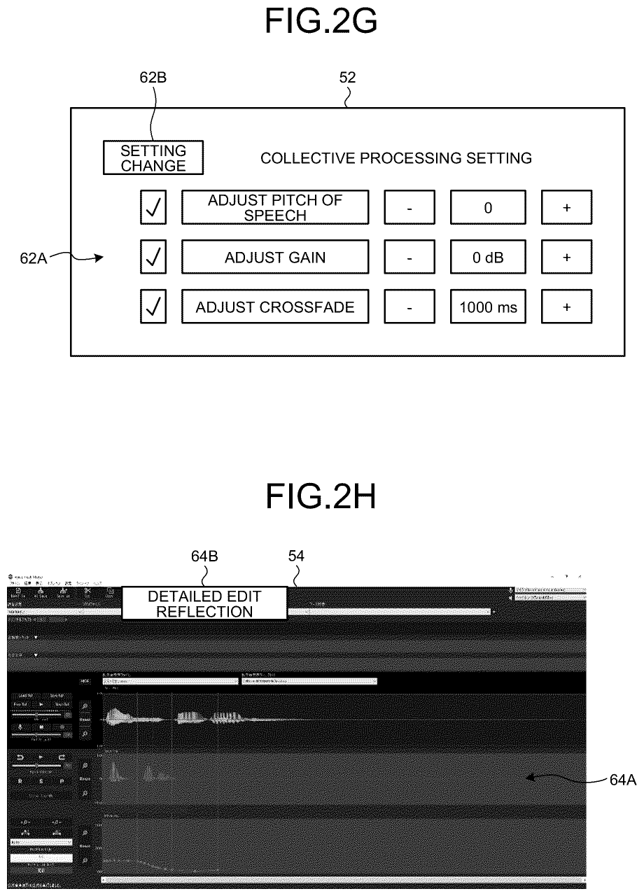

FIG. 2A is a schematic view of an example of a modification assistance screen 50. The display control unit 21 displays the modification assistance screen 50 illustrated in FIG. 2A, for example, when the user operates the operation input unit 16A to input an instruction to start speech modification assistance.

The modification assistance screen 50 includes a selection field 60A. The selection field 60A is an input field for receiving selection of the basic recorded speech data 70 as a processing target desired by the user from one or more pieces of basic recorded speech data 70.

For example, a case where the selection field 60A of the modification assistance screen 50 is operated according to an operation instruction of the operation input unit 16A from the user is assumed. When the selection field 60A is operated, the display control unit 21 displays a list of one or more pieces of basic recorded speech data 70 stored in the storage unit 12 on the display unit 14A. The user operates the operation input unit 16A to select one piece of basic recorded speech data 70 as a desired processing target from among the one or more pieces of displayed basic recorded speech data 70. The first reception unit 22A receives, as the target recorded speech data, one piece of basic recorded speech data 70 of which the selection is (has been) received via the selection field 60A.

FIG. 2B is a schematic view of an example of the modification assistance screen 50. FIG. 2B illustrates, as an example, a case where the first reception unit 22A receives selection of target recorded speech data 72. When the first reception unit 22A receives the selection of the target recorded speech data 72, the display control unit 21 displays a file name of the target recorded speech data 72, which is the basic recorded speech data 70 selected as the processing target by the user, in the selection field 60A of the modification assistance screen 50.

In the present embodiment, a case where a data format of speech data such as the basic recorded speech data 70 or the target recorded speech data 72 is a waveform audio file format (WAV) will be described as an example. However, the data format of the speech data is not limited to the WAV.

Returning to FIG. 1, the description will be continued.

The conversion unit 23 converts the target recorded speech data 72 of which the selection is received into a basic character string. The basic character string is data representing a speech represented by the target recorded speech data 72 in a character string. It is sufficient if the conversion unit 23 converts the target recorded speech data 72 into the basic character string by using a known speech conversion technology for converting speech data into a character string. The speech data is data representing a speech. In the present embodiment, the speech data collectively refer to the recorded speech data such as the basic recorded speech data 70 or the target recorded speech data 72, and synthesized speech data other than the recorded speech data.

The display control unit 21 displays the basic character string obtained by converting the target recorded speech data 72 of which the selection is received into the basic character string. In the present embodiment, the display control unit 21 displays, on the display unit 14A, the basic character string converted by the conversion unit 23.

This will be described with reference to FIG. 2B. When the first reception unit 22A receives the selection of the target recorded speech data 72, the display control unit 21 displays a basic character string 82 of the target recorded speech data 72 of which the selection is received, in a display field 60B of the modification assistance screen 50.

The display field 60B is a display field of an output target character string 86. The output target character string 86 is a character string of modified speech data to be output by the speech modification assistance apparatus 10. The output target character string 86 displayed in the display field 60B changes according to an input content regarding the modification input according to the operation instruction from the user (details are described below).

In a stage where the first reception unit 22A receives the selection of the target recorded speech data 72, the display control unit 21 displays the basic character string 82 of the target recorded speech data 72 of which the selection is received in the display field 60B of the modification assistance screen 50.

FIG. 2B illustrates, as an example, a case where the basic character string 82 “I have a close friend named Masao” is displayed in the display field 60B. The user can easily confirm the basic character string 82 of the selected target recorded speech data 72 by viewing the modification assistance screen 50.

When the first reception unit 22A receives the selection of the target recorded speech data 72, the display control unit 21 displays a return button 60C and a reproduce button 60F on the modification assistance screen 50 so as to be selectable by the user. The return button 60C is an input button for the user to give an operation instruction when giving an instruction to return to a previous display screen. The reproduce button 60F is an input button for the user to give an operation instruction when giving an instruction to reproduce the speech data.

Returning to FIG. 1, the description will be continued.

The second reception unit 22B receives designation of a change target character string in the displayed basic character string 82. The change target character string is a change target character string among character strings included in the basic character string 82. In other words, the change target character string is a character string corresponding to a speech in a speech segment as a speech change target in the target recorded speech data 72. The change target character string may be one character or a plurality of characters.

This will be described with reference to FIG. 2C. FIG. 2C is a schematic view of an example of the modification assistance screen 50. FIG. 2C illustrates, as an example, a case where the second reception unit 22B receives designation of a change target character string 82A.

For example, the user designates the change target character string 82A to be changed in the basic character string 82 displayed in the display field 60B by operating the operation input unit 16A. FIG. 2C illustrates, as an example, a case where “Masao” is designated as the change target character string 82A in the basic character string 82 “I have a close friend named Masao”.

When the user operates the operation input unit 16A to designate the change target character string 82A, the second reception unit 22B receives the designation of the change target character string 82A. In the example illustrated in FIG. 2C, the second reception unit 22B receives the change target character string 82A “Masao”.

The display control unit 21 displays a region of the change target character string 82A designated by the user in a display form different from that of other undesignated character strings in the basic character string 82. FIG. 2C illustrates, as an example, a case where a background portion of a region of a changed character string 84B (i.e., a character string after changed) for which designation is received is highlighted. The user can easily designate the changed character string 84B in the basic character string 82 and confirm the designated changed character string 84B by operating the operation input unit 16A while viewing the modification assistance screen 50.

When the second reception unit 22B receives the designation of the change target character string 82A, the display control unit 21 further displays a save button 60G on the modification assistance screen 50 in a selectable manner. The save button 60G is an input button for the user to give an operation instruction when giving an instruction to save the modified speech data corresponding to the output target character string 86 that is the character string displayed in the display field 60B. The display control unit 21 may display the save button 60G on the modification assistance screen 50 in a selectable manner before receiving the designation of the change target character string 82A. For example, the display control unit 21 may display the save button 60G on the modification assistance screen 50 in a selectable manner in the stages of FIGS. 2A and 2B.

Returning to FIG. 1, the description will be continued. The generation control unit 24 generates the modified speech data corresponding to the target recorded speech data 72 and the change target character string 82A.

As illustrated in FIG. 2C, a case where the designation of the change target character string 82A included in the basic character string 82 is received is assumed. In this case, since information regarding modification of the speech is not input yet, the generation control unit 24 generates the target recorded speech data 72 as the modified speech data.

A case where the reproduce button 60F is operated according to an operation instruction of the operation input unit 16A from the user is assumed. When the operation instruction is given to the reproduce button 60F, the sixth reception unit 22F receives an instruction to reproduce the modified speech data. When the sixth reception unit 22F receives the instruction to reproduce the modified speech data, the reproduction control unit 26 reproduces the modified speech data. Specifically, the reproduction control unit 26 outputs, from the microphone 16B, the modified speech data generated by the generation control unit 24 immediately before.

The user can listen to a modified speech represented by the modified speech data by operating the reproduce button 60F using the operation input unit 16A.

In addition, a case where the save button 60G is operated according to an operation instruction of the operation input unit 16A from the user is assumed. When the operation instruction is given to the save button 60G, the reception unit 22 receives a save instruction.

Returning to FIG. 1, the description will be continued.

The storing processing unit 27 stores, in the storage unit 12, the modified speech data generated by the generation control unit 24. Specifically, when the reception unit 22 receives the save instruction from the operation input unit 16A, the storing processing unit 27 stores the modified speech data generated by the generation control unit 24 in the storage unit 12.

In addition, the storing processing unit 27 stores modification-related information in the storage unit 12 in association with the modified speech data.

The modification-related information is information regarding modification of the modified speech data. Specifically, the modification-related information is information used to generate the modified speech data. Specifically, the modification-related information includes at least one of the target recorded speech data 72 used to generate the modified speech data and identification information of the target recorded speech data 72, the basic character string 82, and the change target character string 82A. In addition, the modification-related information may further include at least one of the changed character string, teaching recorded speech data, setting change information, and detailed edit information according to a modification content of the modified speech data. Details of the teaching recorded speech data, the changed character string, the setting change information, and the detailed edit information are described below.

A case where the operation instruction is given to the save button 60G in a stage where the user operates the operation input unit 16A to select the target recorded speech data 72 and designate the change target character string 82A in the basic character string 82 of the target recorded speech data 72 is assumed. Furthermore, a case where the generation control unit 24 generates the target recorded speech data 72 as the modified speech data is assumed. In this case, the storing processing unit 27 stores the modification-related information including the target recorded speech data 72 or the identification information of the target recorded speech data 72, the basic character string 82, and the change target character string 82A in the storage unit 12 in association with the modified speech data.

The third reception unit 22C receives an input of the changed character string for the change target character string 82A. The changed character string is a character string obtained by replacing the change target character string 82A with another character string desired by the user. In other words, the changed character string is a character string representing a phoneme or a phoneme group after replacement of a phoneme in a change target speech segment corresponding to the change target character string 82A in the target recorded speech data 72. The changed character string may be one character or a plurality of characters.

This will be described with reference to FIG. 2D. FIG. 2D is a schematic view of an example of the modification assistance screen 50. FIG. 2D illustrates, as an example, a scene where third reception unit 22C receives the input of the changed character string 84B.

As described with reference to FIG. 2C, a case where the user operates the operation input unit 16A to select “Masao” in the basic character string 82 displayed in the display field 60B as the change target character string 82A is assumed. Then, a case where the user further operates the operation input unit 16A to input the changed character string 84B “Takumi” instead of the change target character string 82A “Masao” is assumed.

In this case, the third reception unit 22C receives an input of the changed character string 84B “Takumi” from the operation input unit 16A.

The display control unit 21 replaces the change target character string 82A in the basic character string 82 with the changed character string 84B and displays the changed character string in the display field 60B of the modification assistance screen 50. Therefore, a character string obtained by replacing a portion corresponding to the change target character string 82A included in the basic character string 82 with the changed character string 84B is displayed as the output target character string 86 on the modification assistance screen 50.

When the input of the changed character string 84B is received, the generation control unit 24 generates the modified speech data corresponding to the target recorded speech data 72 and the changed character string 84B for the change target character string 82A.

Specifically, the generation control unit 24 generates the modified speech data obtained by synthesizing changed character string speech data of the changed character string 84B with the change target speech segment corresponding to the change target character string 82A in the target recorded speech data 72. The change target speech segment is a speech segment of a phoneme or a phoneme group represented by the change target character string 82A in the target recorded speech data 72.

Specifically, a case where the changed character string 84B “Takumi” is input instead of the change target character string 82A “Masao” included in the basic character string 82 as illustrated in FIG. 2D is assumed. In this case, the generation control unit 24 specifies the change target speech segment which is a speech segment corresponding to the change target character string 82A “Masao” in the target recorded speech data 72. It is sufficient if a known method may be used for such specification.

In addition, the generation control unit 24 generates the changed character string speech data that is a speech of the changed character string 84B “Takumi”. The generation control unit 24 is only required to generate the changed character string speech data of the changed character string 84B “Takumi” by using, for example, a known conversion method of converting a character string into speech data of a synthesized speech.

Then, the generation control unit 24 generates the modified speech data by synthesizing the generated changed character string speech data with the specified change target speech segment in the target recorded speech data 72.

When the third reception unit 22C receives the input of the changed character string 84B, the display control unit 21 further displays a detailed edit button 60D, a simple teaching button 60E, and a setting change button 60H on the modification assistance screen 50 in a selectable manner in addition to the return button 60C, the reproduce button 60F, and the save button 60G. Details of the detailed edit button 60D, the simple teaching button 60E, and the setting change button 60H are described below.

In this stage, a case where the reproduce button 60F or the save button 60G is operated according to an operation instruction of the operation input unit 16A from the user is assumed. In other words, a case where the operation instruction is given to the reproduce button 60F or the save button 60G in a stage where the user operates the operation input unit 16A to select the target recorded speech data 72, designate the change target character string 82A in the basic character string 82 of the target recorded speech data 72, and further input the changed character string 84B for the change target character string 82A is assumed.

In this case, the reproduction control unit 26 and the storing processing unit 27 are only required to execute the same processing as described above.

Specifically, it is assumed that the user operates the operation input unit 16A to give the operation instruction to the reproduce button 60F. In this case, the reproduction control unit 26 reproduces the modified speech data generated immediately before by the generation control unit 24. Specifically, the reproduction control unit 26 reproduces the modified speech data representing the output target character string 86 “I have a close friend named Takumi” for which the change target character string 82A “Masao” in the basic character string 82 is changed to the changed character string 84B “Takumi”.

Furthermore, in this case, a case where the user operates the operation input unit 16A to give the operation instruction to the save button 60G is assumed. In this case, the storing processing unit 27 stores the modified speech data generated by the generation control unit 24 in the storage unit 12. In addition, the storing processing unit 27 stores the modification-related information including the target recorded speech data 72 or the identification information of the target recorded speech data 72, the basic character string 82, the change target character string 82A, and the changed character string 84B in the storage unit 12 in association with the modified speech data.

Next, a case where the simple teaching button 60E is operated according to an operation instruction of the operation input unit 16A from the user is assumed. The simple teaching button 60E is an input button for the user to give an operation instruction when giving an instruction to record a new uttered speech of the output target character string 86.

Returning to FIG. 1, the description will be continued. When the simple teaching button 60E is operated, the acquisition unit 25 acquires, as teaching recorded speech data 74, an uttered speech of the user for the output target character string 86 obtained by converting the change target character string 82A included in the basic character string 82 into the changed character string 84B.

This will be described with reference to FIG. 2E. FIG. 2E is a schematic view of an example of the modification assistance screen 50. FIG. 2E illustrates, as an example, a case where the operation instruction is given to the simple teaching button 60E after the third reception unit 22C receives the input of the changed character string 84B.

When the operation instruction is given to the simple teaching button 60E, the reception unit 22 receives a recording instruction from the operation input unit 16A. When the recording instruction is received from the reception unit 22, the acquisition unit 25 starts recording of the speech data collected by the microphone 16B, and acquires the recorded speech data as the teaching recorded speech data.

For example, after giving the operation instruction to the simple teaching button 60E, the user utters a speech with a desired acoustic feature amount while viewing the output target character string 86 displayed in the display field 60B. In this stage, the character string obtained by changing the change target character string 82A of the basic character string 82 to the changed character string 84B is displayed in the display field 60B as the output target character string 86. The user utters the speech of the output target character string 86 “I have a close friend named Takumi”, which is obtained by changing the change target character string 82A “Masao” in the basic character string 82 to the changed character string 84B “Takumi”, with a desired acoustic feature amount.

Then, for example, when the user gives the operation instruction again to the simple teaching button 60E, an uttered speech of the user during a period from the immediately previous operation instruction for the simple teaching button 60E to the current operation instruction for the simple teaching button 60E is recorded. Then, the acquisition unit 25 acquires the uttered speech of the user corresponding to the output target character string 86 “I have a close friend named Takumi” as the teaching recorded speech data.

As illustrated in FIG. 2E, while the user is recording the uttered speech, the display control unit 21 may change the simple teaching button 60E to a recording button 60E′ with characters representing “recording” and display the recording button 60E′. When the recording is finished, the display control unit 21 displays the simple teaching button 60E instead of the recording button 60E′.

Returning to FIG. 1, the description will be continued. When the acquisition unit 25 acquires the teaching recorded speech data, the generation control unit 24 generates the modified speech data corresponding to the target recorded speech data 72, the changed character string 84B for the change target character string 82A, and the teaching recorded speech data.

This will be described with reference to FIG. 2F. FIG. 2F is an explanatory diagram of an example of generation of modified speech data 76.

A case where the acquisition unit 25 acquires the teaching recorded speech data 74 is assumed. As described above, the teaching recorded speech data 74 is recorded speech data obtained by recording the uttered speech of the user corresponding to the output target character string 86 obtained by converting the change target character string 82A included in the basic character string 82 into the changed character string 84B.

The generation control unit 24 specifies changed recorded speech data 74B of the speech segment corresponding to the changed character string 84B in the teaching recorded speech data 74. In addition, the generation control unit 24 specifies a change target speech segment 72A which is a speech segment corresponding to the change target character string 82A in the target recorded speech data 72. Then, the generation control unit 24 generates the modified speech data 76 by synthesizing the changed recorded speech data 74B specified from the teaching recorded speech data 74 with the change target speech segment 72A in the target recorded speech data 72.

Specifically, the generation control unit 24 synthesizes the changed recorded speech data 74B corresponding to the changed character string 84B “Takumi” included in the teaching recorded speech data 74 with the change target speech segment 72A of the change target character string 82A “Masao” included in the basic character string 82 “I have a close friend named Masao” in the target recorded speech data 72. Through these steps of synthesis processing, the generation control unit 24 generates the modified speech data 76 corresponding to the output target character string 86.

Specifically, for example, the generation control unit 24 generates the modified speech data 76 by sequentially or collectively executing the following steps of processing.

The generation control unit 24 adjusts a pitch of the speech represented by the changed recorded speech data 74B in the speech segment corresponding to the changed character string 84B specified from the teaching recorded speech data 74 to a pitch of the speech of the change target speech segment 72A in the target recorded speech data 72. The pitch of the speech may be referred to as a key or a pitch level.

Furthermore, the generation control unit 24 reflects prosody of the change target speech segment 72A in the target recorded speech data 72 to the changed recorded speech data 74B for which the pitch of the speech is adjusted. Reflecting the prosody means applying the prosody. That is, the generation control unit 24 adjusts prosody of the changed recorded speech data 74B for which the pitch of the speech is adjusted to match the prosody of the change target speech segment 72A in the target recorded speech data 72.

Then, the generation control unit 24 generates the modified speech data 76 by synthesizing the changed recorded speech data 74B obtained by reflecting the prosody with the change target speech segment 72A in the target recorded speech data 72.

It is sufficient if a known method is used to synthesize the changed recorded speech data 74B with the target recorded speech data 72. It is sufficient if examples of the known method used for the synthesis include mixing using a silent part, crossfade, or the like.

Specifically, the generation control unit 24 specifies the changed recorded speech data 74B of the changed character string 84B “Takumi” from the teaching recorded speech data 74 of the uttered speech of the output target character string 86 “I have a close friend named Takumi” newly recorded by the user. Then, the generation control unit 24 adjusts the pitch of the speech of the changed recorded speech data 74B of the changed character string 84B “Takumi” to the pitch of the speech of the change target speech segment 72A, which is the speech segment of “Masao” in the target recorded speech data 72 of the basic character string 82 “I have a close friend named Masao”.

Furthermore, the generation control unit 24 adjusts the prosody of the changed recorded speech data 74B “Takumi” for which the pitch of the speech is adjusted to the prosody of the change target speech segment 72A “Masao” in the target recorded speech data 72 of the basic character string 82 “I have a close friend named Masao”.

Then, the generation control unit 24 generates the modified speech data 76 by synthesizing the changed recorded speech data 74B “Takumi” for which the prosody is adjusted with the speech segment of the change target speech segment 72A “Masao” in the target recorded speech data 72.

In this stage, a case where the reproduce button 60F or the save button 60G is operated according to an operation instruction of the operation input unit 16A from the user is assumed. That is, a case where the operation instruction is given to the save button 60G in a stage where the modified speech data 76 using the teaching recorded speech data 74 is generated is assumed.

In this case, the reproduction control unit 26 and the storing processing unit 27 are only required to execute the same processing as described above.

Specifically, it is assumed that the user operates the operation input unit 16A to give the operation instruction to the reproduce button 60F. In this case, the reproduction control unit 26 reproduces the modified speech data 76 generated immediately before by the generation control unit 24. Specifically, the reproduction control unit 26 reproduces the modified speech data 76 obtained by synthesizing the changed recorded speech data 74B corresponding to the changed character string 84B in the teaching recorded speech data 74 with the change target speech segment 72A corresponding to the change target character string 82A in the target recorded speech data 72.

Furthermore, in this case, a case where the user operates the operation input unit 16A to give the operation instruction to the save button 60G is assumed. In this case, the storing processing unit 27 stores the modified speech data 76 generated immediately before by the generation control unit 24 in the storage unit 12. In addition, the storing processing unit 27 stores the modification-related information including the target recorded speech data 72 or the identification information of the target recorded speech data 72, the basic character string 82, the change target character string 82A, the changed character string 84B, and the teaching recorded speech data 74 in the storage unit 12 in association with the modified speech data.

Next, a case where the setting change button 60H is operated according to an operation instruction of the operation input unit 16A from the user is assumed.

The setting change button 60H described with reference to FIG. 2E is an input button for the user to give an operation instruction when giving an instruction to change setting of at least one of the acoustic feature amount of the speech of the changed character string 84B and the synthesis method.

When the setting change button 60H is operated according to the operation instruction of the operation input unit 16A from the user, the display control unit 21 displays a setting change screen 52 on the display unit 14A.

FIG. 2G is a schematic view of an example of the setting change screen 52. The setting change screen 52 includes a setting change input field 62A and a setting change reflection button 62B. The setting change input field 62A is an input field for receiving a setting change of at least one of the acoustic feature amount of the speech of the changed character string 84B and the synthesis method. FIG. 2G illustrates, as an example, an input field for adjusting each of the pitch and a gain (volume) of the speech as the acoustic feature amount. In addition, FIG. 2G illustrates, as an example, an input field for adjusting the crossfade as the synthesis method.

The user operates the operation input unit 16A while viewing the setting change screen 52 to input setting change information of at least one of the acoustic feature amount of the speech of the changed character string 84B and the synthesis method. The setting change information is information indicating at least one of the acoustic feature amount and the synthesis method after the setting change of the changed character string 84B.

Furthermore, when the setting change reflection button 62B is operated according to an operation instruction of the operation input unit 16A from the user, the operation input unit 16A outputs the setting change information input via the setting change screen 52 to the processing unit 20.

Returning to FIG. 1, the description will be continued.

The fourth reception unit 22D receives an input of the setting change information from the operation input unit 16A. That is, the fourth reception unit 22D receives the input of the setting change information of at least one of the acoustic feature amount of the speech of the changed character string 84B and the synthesis method.

In a case where the fourth reception unit 22D receives the input of the setting change information, the generation control unit 24 adjusts the acoustic feature amount of the speech data in the speech segment of the changed character string 84B to the acoustic feature amount included in the setting change information of which the input is received. Then, the generation control unit 24 generates the modified speech data 76 obtained by synthesizing the speech data in the speech segment of the changed character string 84B for which the acoustic feature amount is adjusted with the change target speech segment 72A in the target recorded speech data 72 according to the synthesis method included in the setting change information.

For example, a case where the setting change button 60H is operated according to an operation instruction of the operation input unit 16A from the user in a stage where the acquisition unit 25 acquires the teaching recorded speech data 74 is assumed. Then, a case where the setting change information is input via the setting change screen 52 according to an operation instruction of the operation input unit 16A from the user is assumed.

In this case, the generation control unit 24 adjusts the acoustic feature amount of the speech represented by the changed recorded speech data 74B specified from the teaching recorded speech data 74 to the acoustic feature amount included in the setting change information. For example, the generation control unit 24 adjusts the pitch and the gain of the speech represented by the changed recorded speech data 74B specified from the teaching recorded speech data 74 to the pitch and the gain of the speech included in the setting change information. Then, the generation control unit 24 generates the modified speech data 76 by synthesizing the changed recorded speech data 74B for which the acoustic feature amount is adjusted with the target recorded speech data 72 according to the synthesis method included in the setting change information.

In this stage, a case where the reproduce button 60F or the save button 60G is operated according to an operation instruction of the operation input unit 16A from the user is assumed. That is, a case where the operation instruction is given to the save button 60G in a stage where the modified speech data 76 for which at least one of the acoustic feature amount and the synthesis method is adjusted according to the setting change information is generated is assumed.

In this case, the reproduction control unit 26 and the storing processing unit 27 are only required to execute the same processing as described above.

Specifically, it is assumed that the user operates the operation input unit 16A to give the operation instruction to the reproduce button 60F. In this case, the reproduction control unit 26 reproduces the modified speech data 76 for which at least one of the acoustic feature amount and the synthesis method is adjusted according to the setting change information.

Furthermore, in this case, a case where the user operates the operation input unit 16A to give the operation instruction to the save button 60G is assumed. In this case, the storing processing unit 27 stores the modified speech data 76 generated by the generation control unit 24 in the storage unit 12. In addition, the storing processing unit 27 stores the modification-related information including the target recorded speech data 72 or the identification information of the target recorded speech data 72, the basic character string 82, the change target character string 82A, the changed character string 84B, the teaching recorded speech data 74, and the setting change information in the storage unit 12 in association with the modified speech data 76.

Next, a case where the detailed edit button 60D is operated according to an operation instruction of the operation input unit 16A from the user is assumed.

The detailed edit button 60D is an input button for the user to give an operation instruction when giving an instruction to perform detailed editing of at least one of the acoustic feature amount of the speech of the changed character string 84B and the synthesis method. In other words, the detailed edit button 60D is an input button for the user to give an operation instruction when giving an instruction to perform more detailed editing as compared to the setting change button 60H.

When the detailed edit button 60D is operated according to an operation instruction of the operation input unit 16A from the user, the display control unit 21 displays a detailed edit screen on the display unit 14A.

FIG. 2H is a schematic view of an example of a detailed edit screen 54. The detailed edit screen 54 includes a detailed edit input field 64A and a detailed edit reflection button 64B. The detailed edit input field 64A is an input field for receiving an input of detailed edit information of at least one of the acoustic feature amount of the speech of the changed character string 84B and the synthesis method. For example, a screen on which the acoustic feature amount such as the prosody and the synthesis method such as a crossfade point can be set in detail is displayed in the detailed edit input field 64A.

The user operates the operation input unit 16A while viewing the detailed edit screen 54 to input the detailed edit information of at least one of the acoustic feature amount of the speech of the changed character string 84B and the synthesis method. The detailed edit information is information indicating at least one of the detailed acoustic feature amount of the changed character string 84B and the detailed synthesis method.

Returning to FIG. 1, the description will be continued.

The fifth reception unit 22E receives an input of the detailed edit information of at least one of the acoustic feature amount of the speech of the changed character string 84B and the synthesis method.

In a case where the fifth reception unit 22E receives the input of the detailed edit information, the generation control unit 24 adjusts the acoustic feature amount of the speech data of the changed character string 84B to the acoustic feature amount included in the detailed edit information of which the input is received. Then, the generation control unit 24 generates the modified speech data 76 obtained by synthesizing the speech data in the speech segment of the changed character string 84B for which the acoustic feature amount is adjusted with the change target speech segment 72A in the target recorded speech data 72 according to the synthesis method included in the detailed edit information.

For example, a case where the detailed edit button 60D is operated according to an operation instruction of the operation input unit 16A from the user in a stage where the acquisition unit 25 acquires the teaching recorded speech data 74 is assumed. Then, a case where the detailed edit information is input via the detailed edit screen 54 according to an operation instruction of the operation input unit 16A from the user is assumed.

In this case, the generation control unit 24 adjusts the acoustic feature amount of the speech represented by the changed recorded speech data 74B specified from the teaching recorded speech data 74 to the acoustic feature amount included in the detailed edit information. For example, the generation control unit 24 adjusts the acoustic feature amounts such as the prosody and accent of the speech represented by the changed recorded speech data 74B specified from the teaching recorded speech data 74 to the acoustic feature amounts such as the prosody and accent included in the detailed edit information. Then, the generation control unit 24 generates the modified speech data 76 by synthesizing the changed recorded speech data 74B for which the acoustic feature amount is adjusted according to the synthesis method included in the detailed edit information.

In this stage, a case where the reproduce button 60F or the save button 60G is operated according to an operation instruction of the operation input unit 16A from the user is assumed. That is, a case where the operation instruction is given to the save button 60G in a stage where the modified speech data 76 for which at least one of the acoustic feature amount and the synthesis method is adjusted according to the detailed edit information is generated is assumed.

In this case, the reproduction control unit 26 and the storing processing unit 27 are only required to execute the same processing as described above.

Specifically, it is assumed that the user operates the operation input unit 16A to give the operation instruction to the reproduce button 60F. In this case, the reproduction control unit 26 reproduces the modified speech data 76 for which at least one of the acoustic feature amount and the synthesis method is adjusted according to the detailed edit information.

Furthermore, in this case, a case where the user operates the operation input unit 16A to give the operation instruction to the save button 60G is assumed. In this case, the storing processing unit 27 stores the modified speech data 76 generated by the generation control unit 24 in the storage unit 12. In addition, the storing processing unit 27 stores the modification-related information including the target recorded speech data 72 or the identification information of the target recorded speech data 72, the basic character string 82, the change target character string 82A, the changed character string 84B, the teaching recorded speech data 74, and the detailed edit information in the storage unit 12 in association with the modified speech data.

Returning to FIG. 1, the description will be continued.

Next, the information processing apparatus 30 will be described.

The information processing apparatus 30 is an information processing apparatus that modifies the target recorded speech data 72 by using the modification-related information generated by the speech modification assistance apparatus 10.

The information processing apparatus 30 includes a storage unit 32, an output unit 34, an input unit 36, a communication unit 38, and a processing unit 40. The storage unit 32, the output unit 34, the input unit 36, the communication unit 38, and the processing unit 40 are communicably connected via a bus 39.

The storage unit 32 stores various data. The output unit 34 is an output device for outputting various types of information. In the present embodiment, the output unit 34 includes a display unit and a speaker. The display unit and the speaker are similar to the display unit 14A and the speaker 14B of the speech modification assistance apparatus 10.

The input unit 36 is an input device for receiving various instructions from the user. The input unit 36 is, for example, a pointing device such as a digital pen, a mouse, or a trackball, or an input device such as a keyboard or a microphone.

The communication unit 38 communicates with an external information processing apparatus via the network NW. In the present embodiment, the communication unit 38 communicates with the speech modification assistance apparatus 10 via the network NW.

The processing unit 40 executes various types of information processing. The processing unit 40 includes a reception unit 41 and a modification processing unit 42. The reception unit 41 and the modification processing unit 42 are implemented by, for example, one or more processors.

The reception unit 41 receives the modification-related information from the speech modification assistance apparatus 10. For example, the reception unit 41 receives the modification-related information from the speech modification assistance apparatus 10 via the communication unit 38, thereby receiving the modification-related information. Furthermore, for example, the reception unit 41 may store the modification-related information generated by the speech modification assistance apparatus 10 in the storage unit 32 via a portable storage medium such as a USB memory, and read the modification-related information from the storage unit 32 to receive the modification-related information.

As described above, the modification-related information is information regarding modification of the modified speech data 76.

The modification processing unit 42 generates modified speech data obtained by modifying the target recorded speech data 72 based on the modification-related information received by the reception unit 41.

For example, the modification processing unit 42 specifies the target recorded speech data 72 included in the modification-related information. In a case where the modification-related information includes the identification information of the target recorded speech data 72, the modification processing unit 42 specifies the target recorded speech data 72 identified by the identification information from the storage unit 32 or the like.

Then, the modification processing unit 42 generates the modified speech data by modifying the specified target recorded speech data 72 according to the modification-related information. The modification processing unit 42 is only required to generate the modified speech data by modifying the specified target recorded speech data 72 similarly to the generation control unit 24 according to the modification-related information.

For example, a case where the modification-related information received by the reception unit 41 includes the target recorded speech data 72, the basic character string 82, the change target character string 82A, the changed character string 84B, the teaching recorded speech data 74, and the detailed edit information is assumed.

In this case, for example, the modification processing unit 42 replaces the change target character string 82A included in the basic character string 82 of the target recorded speech data 72 included in the modification-related information with the changed character string 84B. Then, the modification processing unit 42 adjusts the acoustic feature amount of the changed recorded speech data 74B included in the teaching recorded speech data 74 to the acoustic feature amount included in the detailed edit information. Then, the modification processing unit 42 generates the modified speech data 76 by synthesizing the changed recorded speech data 74B for which the acoustic feature amount is adjusted according to the synthesis method included in the modification-related information.

In addition, the reception unit 41 may receive, from the input unit 36, change information of at least a part of the received modification-related information. The user inputs an instruction to change a part of the information included in the modification-related information by giving an operation instruction to the input unit 36. In this case, the modification processing unit 42 is only required to generate the modified speech data by modifying the target recorded speech data 72 using the changed modification-related information.

For example, a case where the user gives an operation instruction to the input unit 36 to change the change target character string 82A and the changed character string 84B included in the modification-related information is assumed.

In this case, the reception unit 41 receives the change target character string 82A and the changed character string 84B as the change information. The modification processing unit 42 replaces the change target character string 82A represented by the change information in the basic character string 82 of the target recorded speech data 72 included in the modification-related information with the changed character string 84B represented by the change information.

Then, the modification processing unit 42 adjusts the acoustic feature amount of the changed recorded speech data 74B included in the teaching recorded speech data 74 to the acoustic feature amount included in the detailed edit information. Then, the modification processing unit 42 generates the modified speech data 76 by synthesizing the changed recorded speech data 74B for which the acoustic feature amount is adjusted according to the synthesis method included in the modification-related information.

As described above, the information processing apparatus 30 according to the present embodiment modifies the target recorded speech data 72 by using the modification-related information created by the speech modification assistance apparatus 10. Therefore, the information processing apparatus 30 can easily modify the target recorded speech data 72. Furthermore, the information processing apparatus 30 according to the present embodiment receives, from the input unit 36, the change information of at least a part of the received modification-related information, and modifies the target recorded speech data 72 by using the changed modification-related information. Therefore, the information processing apparatus 30 according to the present embodiment can assist in easy adjustment by the user for modification of the recorded speech data such as the target recorded speech data 72.

Next, information processing executed by the speech modification assistance system 1 according to the present embodiment will be described.

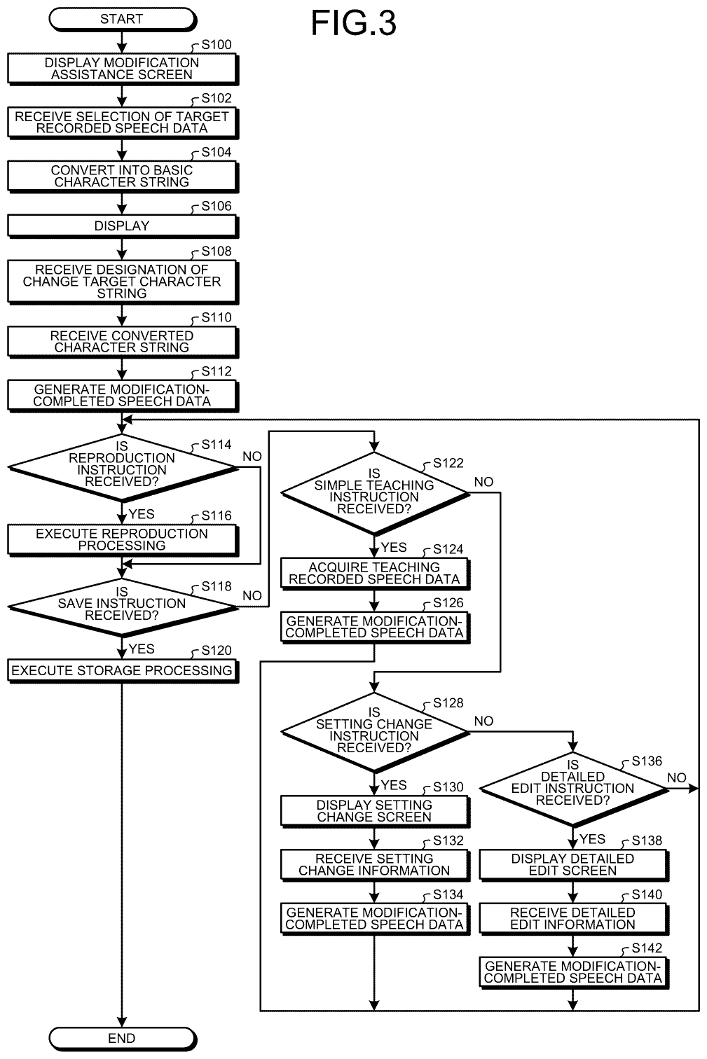

FIG. 3 is a flowchart illustrating an example of a flow of information processing executed by the speech modification assistance apparatus 10 according to the present embodiment.

The display control unit 21 of the speech modification assistance apparatus 10 displays the modification assistance screen 50 on the display unit 14A (step S100). By the processing in step S100, for example, the modification assistance screen 50 illustrated in FIG. 2A is displayed on the display unit 14A.

The first reception unit 22A receives the selection of the target recorded speech data 72 from the basic recorded speech data 70 via the modification assistance screen 50 displayed in step S100 (step S102). The user operates the operation input unit 16A to select one piece of basic recorded speech data 70 as a desired processing target from among the one or more pieces of displayed basic recorded speech data 70. The first reception unit 22A receives, as the target recorded speech data 72, one piece of basic recorded speech data 70 of which the selection is received via the selection field 60A.

The conversion unit 23 converts the target recorded speech data 72 of which the selection is received in step S102 into the basic character string 82 (step S104). The display control unit 21 displays the basic character string 82 converted in step S104 on the display unit 14A (step S106). By the processing in step S106, for example, as illustrated in FIG. 2B, the basic character string 82 is displayed in the display field 60B of the modification assistance screen 50.

The second reception unit 22B receives the designation of the change target character string 82A in the displayed basic character string 82 (step S108). By the processing in step S108, as illustrated in FIG. 2C, for example, “Masao” in the basic character string 82 “I have a close friend named Masao” displayed in the display field 60B is designated as the change target character string 82A.

Next, the third reception unit 22C receives the input of the changed character string 84B for the change target character string 82A received in step S108 (step S110). As illustrated in FIG. 2D, the user operates the operation input unit 16A to input the changed character string 84B “Takumi” instead of the change target character string 82A “Masao”, for example. When the changed character string 84B is input, the third reception unit 22C receives the input of the changed character string 84B.

When the input of the changed character string 84B is received, the generation control unit 24 generates the modified speech data 76 corresponding to the target recorded speech data 72 and the changed character string 84B for the change target character string 82A (step S112). In step S122, the generation control unit 24 generates the modified speech data 76 obtained by synthesizing the changed recorded speech data 74B of the changed character string 84B with the change target speech segment 72A corresponding to the change target character string 82A in the target recorded speech data 72.

Next, the reception unit 22 determines whether or not a reproduction instruction is received (step S114).

The reception unit 22 determines whether or not the reproduce button 60F is operated according to an operation instruction of the operation input unit 16A from the user and the reproduction instruction is received from the operation input unit 16A, thereby performing the determination in step S114. In a case where a negative determination is made in step S114 (step S114: No), the processing proceeds to step S118 described below.

In a case where the reproduction instruction is received (step S114: Yes), the reproduction control unit 26 executes reproduction processing of reproducing the modified speech data 76 generated immediately before by the generation control unit 24 (step S116).

Next, the reception unit 22 determines whether or not a save instruction is received (step S118). In a case where the save instruction is received (step S118: Yes), the processing proceeds to step S120.

In step S120, the storing processing unit 27 executes storage processing (step S120). The storing processing unit 27 stores the modified speech data 76 generated immediately before in the storage unit 12. In addition, the storing processing unit 27 stores the modification-related information regarding the modification of the modified speech data 76 in the storage unit 12 in association with the modified speech data 76. Then, this routine ends.

On the other hand, in a case where a negative determination is made in step S118 (step S118: No), the processing proceeds to step S122.

In step S122, the reception unit 22 determines whether or not a simple teaching instruction is received (step S122). The reception unit 22 determines whether or not the simple teaching button 60E is operated according to an operation instruction of the operation input unit 16A from the user and the simple teaching instruction is received from the simple teaching button 60E, thereby performing the determination in step S122.

In a case where it is determined that the simple teaching instruction is received (step S122: Yes), the processing proceeds to step S124. In step S124, the acquisition unit 25 acquires, as the teaching recorded speech data 74, an uttered speech of the user for the output target character string 86 obtained by converting the change target character string 82A included in the basic character string 82 into the changed character string 84B (step S124).

The generation control unit 24 generates the modified speech data 76 corresponding to the target recorded speech data 72, the changed character string 84B for the change target character string 82A, and the teaching recorded speech data 74 acquired in step S124 (step S126). As illustrated in FIG. 2F, for example, the generation control unit 24 specifies the changed recorded speech data 74B of the speech segment corresponding to the changed character string 84B in the teaching recorded speech data 74. In addition, the generation control unit 24 specifies the change target speech segment 72A corresponding to the change target character string 82A in the target recorded speech data 72. Then, the generation control unit 24 generates the modified speech data 76 by synthesizing the changed recorded speech data 74B specified from the teaching recorded speech data 74 with the change target speech segment 72A in the target recorded speech data 72. Then, the processing proceeds to step S114 described above.

In a case where a negative determination is made in step S122 (step S122: No), the processing proceeds to step S128. In step S128, the reception unit 22 determines whether or not a setting change instruction is received (step S128). The reception unit 22 determines whether or not the setting change button 60H is operated according to an operation instruction of the operation input unit 16A from the user, and the setting change instruction is received from the setting change button 60H, thereby performing the determination in step S128.

In a case where it is determined that the setting change instruction is received (step S128: Yes), the processing proceeds to step S130. In step S130, the display control unit 21 displays the setting change screen 52 on the display unit 14A (step S130). By the processing in step S130, for example, the setting change screen 52 illustrated in FIG. 2G is displayed. The user operates the operation input unit 16A while viewing the setting change screen 52 to input setting change information of at least one of the acoustic feature amount of the speech of the changed character string 84B and the synthesis method. When the setting change reflection button 62B is operated according to an operation instruction of the operation input unit 16A from the user, the fourth reception unit 22D receives the input of the setting change information (step S132).

The generation control unit 24 generates the modified speech data 76 according to the setting change information received in step S132 (step S134). The generation control unit 24 adjusts the acoustic feature amount of the speech data in the speech segment of the changed character string 84B to the acoustic feature amount included in the setting change information received in step S132. Then, the generation control unit 24 generates the modified speech data 76 obtained by synthesizing the speech data in the speech segment of the changed character string 84B for which the acoustic feature amount is adjusted with the change target speech segment 72A in the target recorded speech data 72 according to the synthesis method included in the setting change information received in step S132. Then, the processing proceeds to step S114 described above.

In a case where a negative determination is made in step S128 (step S128: No), the processing proceeds to step S136.

In step S136, the reception unit 22 determines whether or not a detailed edit instruction is received (step S136). The reception unit 22 determines whether or not the detailed edit button 60D is operated according to an operation instruction of the operation input unit 16A from the user and the detailed edit instruction is received from the detailed edit button 60D, thereby performing the determination in step S136. In a case where a negative determination is made in step S136 (step S136: No), the processing proceeds to step S114. In a case where a negative determination is made in step S136, the processing may also proceed to step S102.

In a case where it is determined that the detailed edit instruction is received (step S136: Yes), the processing proceeds to step S138. In step S138, the display control unit 21 displays the detailed edit screen 54 on the display unit 14A (step S138). By the processing in step S140, for example, the detailed edit screen 54 illustrated in FIG. 2H is displayed on the display unit 14A.

The user operates the operation input unit 16A while viewing the detailed edit screen 54 to input the detailed edit information of at least one of the acoustic feature amount of the speech of the changed character string 84B and the synthesis method. When the detailed edit reflection button 64B is operated according to an operation instruction of the operation input unit 16A from the user, the fifth reception unit 22E receives the input of the detailed edit information (step S140).

The generation control unit 24 adjusts the acoustic feature amount of the speech data of the changed character string 84B to the acoustic feature amount included in the detailed edit information of which the input is received. Then, the generation control unit 24 generates the modified speech data 76 obtained by synthesizing the speech data in the speech segment of the changed character string 84B for which the acoustic feature amount is adjusted with the change target speech segment 72A in the target recorded speech data 72 according to the synthesis method included in the detailed edit information (step S142). Then, the processing proceeds to step S114 described above.

Next, an example of a flow of information processing executed by the information processing apparatus 30 according to the present embodiment will be described.

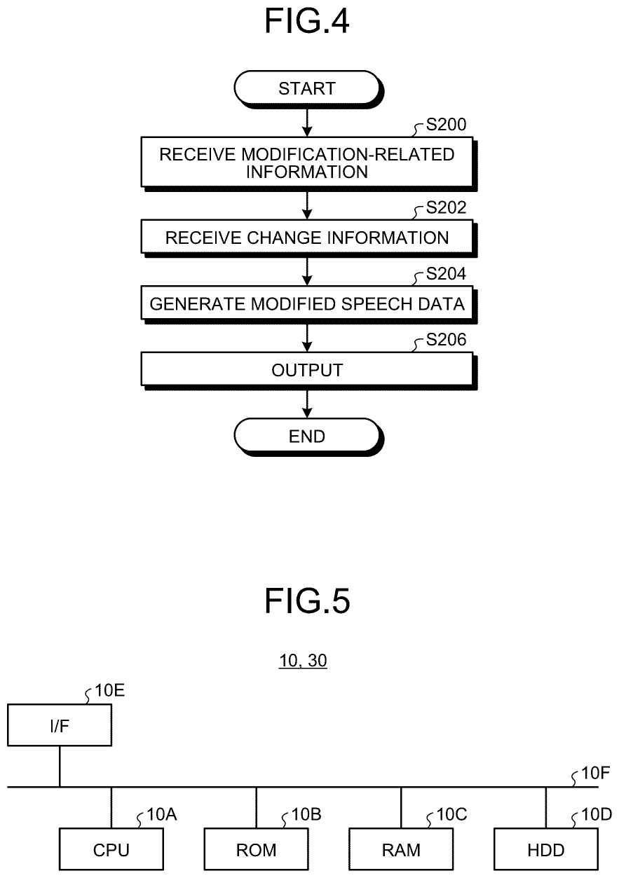

FIG. 4 is a flowchart illustrating an example of the flow of the information processing executed by the information processing apparatus 30 according to the present embodiment.

The reception unit 41 receives the modification-related information from the speech modification assistance apparatus 10 (step S200).

Further, the reception unit 41 receives the change information of at least a part of the modification-related information received in step S200 (step S202).

The modification processing unit 42 generates the modified speech data by using the modification-related information received in step S200 and the change information received in step S202 (step S204). Then, the modification processing unit 42 outputs the modified speech data generated in step S204 to the output unit 34 (step S206). For example, the modification processing unit 42 outputs a speech of the modified speech data generated in step S204 from the microphone included in the output unit 34. The modification processing unit 42 may store the modified speech data generated in step S204 in the storage unit 32. Furthermore, the modification processing unit 42 may transmit the modified speech data generated in step S204 to another external information processing apparatus via the communication unit 38. Then, this routine ends.

As described above, the speech modification assistance apparatus 10 according to the present embodiment includes the first reception unit 22A, the display control unit 21, and the second reception unit 22B. The first reception unit 22A receives the selection of the target recorded speech data 72 which is the basic recorded speech data 70 to be processed from one or more pieces of basic recorded speech data 70 that are recorded. The display control unit 21 converts the target recorded speech data 72 into the basic character string 82 and displays the basic character string 82. The second reception unit 22B receives the designation of the change target character string 82A to be changed in the displayed basic character string 82. The generation control unit 24 generates the modified speech data 76 corresponding to the target recorded speech data 72 and the change target character string 82A.

Here, in the related art, modified speech data obtained by modifying speech data using automatic extraction and automatic synthesis without an operation instruction from a user is generated. For this reason, with the related art, it is difficult to assist in easy adjustment by the user for modification of recorded speech data.

On the other hand, the speech modification assistance apparatus 10 according to the present embodiment receives the selection of the target recorded speech data 72, which is the basic recorded speech data 70 to be processed, by the user from the plurality of pieces of basic recorded speech data 70. Therefore, the user can select desired basic recorded speech data 70 from among the plurality of pieces of basic recorded speech data 70 as the target recorded speech data 72. In addition, the speech modification assistance apparatus 10 according to the present embodiment displays the basic character string 82 of the target recorded speech data 72, and receives the designation of the change target character string 82A to be changed in the basic character string 82. Therefore, the user can specify a desired character string in the basic character string 82 of the target recorded speech data 72 as the change target character string 82A. Then, the generation control unit 24 generates the modified speech data 76 corresponding to the target recorded speech data 72 and the change target character string 82A. Therefore, the generation control unit 24 can generate the modified speech data 76 according to the selection and designation by the user.

That is, in the speech modification assistance apparatus 10 according to the present embodiment, the user can select desired basic recorded speech data 70 as the target recorded speech data 72, and specify desired character string in the basic character string 82 of the target recorded speech data 72 as the change target character string 82A.

Therefore, the speech modification assistance apparatus 10 according to the present embodiment can assist in easy adjustment by the user for modification of the recorded speech data such as the basic recorded speech data 70.

In addition, the speech modification assistance apparatus 10 according to the present embodiment generates the modified speech data 76 corresponding to the target recorded speech data 72 and the change target character string 82A selected from the basic recorded speech data 70.

Therefore, even in a case where it is difficult to obtain an uttered speech having the same voice quality as the basic recorded speech data 70 of the recorded uttered speech, the speech modification assistance apparatus 10 according to the present embodiment can easily generate the modified speech data 76 of a new line having the same or similar voice quality as the basic recorded speech data 70.

The speech modification assistance apparatus 10 according to the present embodiment can further include the third reception unit 22C. The third reception unit 22C receives the input of the changed character string 84B for the change target character string 82A. The generation control unit 24 generates the modified speech data 76 corresponding to the target recorded speech data 72 and the changed character string 84B for the change target character string 82A.

As described above, the speech modification assistance apparatus 10 according to the present embodiment generates the modified speech data 76 corresponding to the target recorded speech data 72 and the changed character string 84B. Therefore, in addition to the above effects, the speech modification assistance apparatus 10 according to the present embodiment can easily generate the modified speech data 76 based on the recorded target recorded speech data 72 having high sound quality and high quality and reflecting a performer's intention and the like.

Here, in the related art, in a case where unrecorded lines or some words are changed even though there are a lot of recorded speeches, it is necessary to perform recording again.

On the other hand, the speech modification assistance apparatus 10 according to the present embodiment generates the modified speech data 76 obtained by replacing the change target speech segment 72A of the change target character string 82A included in the target recorded speech data 72 selected from among the plurality of pieces of basic recorded speech data 70 with the speech data of the changed character string 84B input by the user.

Therefore, in the speech modification assistance apparatus 10 according to the present embodiment, it is not necessary to perform recording again to obtain speech data for which some words are changed even though the plurality of pieces of basic recorded speech data 70 have already been stored. Therefore, the speech modification assistance apparatus 10 according to the present embodiment can achieve an effect of reducing a load on the user in addition to the above effects.

Furthermore, in the related art, even speech data of a speech uttered by the same user may result in modified speech data with a feeling of strangeness when synthesized due to a physical condition of the user who utters a line, a change in vocal cords, or the like. The adjustment of the modified speech data with the feeling of strangeness sometimes requires time and cost.

In addition, in the related art, in the case of creating speech synthesis data of a high-quality uttered speech reflecting a performer's intention, it is necessary to record a large number of pieces of speech data for learning, perform machine learning, and perform verification. For this reason, in the related art, it is not possible to meet a demand for creating acting speeches of many characters in a short period with a low budget. Furthermore, adjustment of the modified speech data by modification of only synthesized speeches sometimes created an impression of taking away jobs from users whose profession involves voice work.

On the other hand, the speech modification assistance apparatus 10 according to the present embodiment generates the modified speech data 76 obtained by replacing the change target speech segment 72A of the change target character string 82A, which is a part of the target recorded speech data 72, with the speech data of the changed character string 84B input by the user based on the target recorded speech data 72 selected from among the plurality of pieces of basic recorded speech data 70.

Therefore, the speech modification assistance apparatus 10 according to the present embodiment can achieve an effect of easily generating the modified speech data 76 in a short period and with a low budget by using the target recorded speech data 72 of the uttered speech of the user, in addition to the above effects.

Next, hardware configurations of the speech modification assistance apparatus 10 and the information processing apparatus 30 according to the present embodiment will be described.

FIG. 5 is a hardware configuration diagram of an example of the speech modification assistance apparatus 10 and the information processing apparatus 30 according to the present embodiment.

The speech modification assistance apparatus 10 and the information processing apparatus 30 according to the present embodiment each include a control device such as a CPU 10A, a storage device such as a read only memory (ROM) 10B or a random access memory (RAM) 10C, a hard disk drive (HDD) 10D, an I/F 10E that is connected to a network and performs communication, and a bus 10F that connects the respective units.

Programs executed by the speech modification assistance apparatus 10 and the information processing apparatus 30 according to the present embodiment may be provided by being incorporated in the ROM 10B or the like in advance.

Programs executed by the speech modification assistance apparatus 10 and the information processing apparatus 30 according to the present embodiment may be recorded in a computer-readable recording medium such as a compact disk read only memory (CD-ROM), a flexible disk (FD), a compact disk recordable (CD-R), and a digital versatile disk (DVD) as a file in an installable format or an executable format and provided as a computer program product.

Furthermore, the program executed by the speech modification assistance apparatus 10 and the information processing apparatus 30 according to the present embodiment may be stored on a computer connected to a network such as the Internet and provided by being downloaded via the network. Furthermore, the program executed by the speech modification assistance apparatus 10 and the information processing apparatus 30 according to the present embodiment may be provided or distributed via a network such as the Internet.

The program executed by the speech modification assistance apparatus 10 and the information processing apparatus 30 according to the present embodiment can cause a computer to function as each unit of the speech modification assistance apparatus 10 described above. In the computer, the CPU 10A can read a program from a computer-readable storage medium onto a main storage device and execute the program.

The above embodiment has been described assuming that the speech modification assistance apparatus 10 and the information processing apparatus 30 are implemented as a single apparatus. However, the speech modification assistance apparatus 10 and the information processing apparatus 30 may be implemented by a plurality of apparatuses physically separated and communicably connected via a network or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech modification assistance apparatus comprising:
one or more hardware processors configured to function as:
a first reception unit configured to receive selection of target recorded speech data, which is basic recorded speech data to be processed, from among one or more pieces of basic recorded speech data that are recorded;
a display control unit configured to convert the target recorded speech data into a basic character string and display the basic character string;
a second reception unit configured to receive designation of a change target character string to be changed in the displayed basic character string; and
a generation control unit configured to generate modified speech data corresponding to the target recorded speech data and the change target character string.

2. The speech modification assistance apparatus according to claim 1, wherein the hardware processors are configured to further function as:
a third reception unit configured to receive an input of a changed character string for the change target character string, wherein
the generation control unit
generates the modified speech data corresponding to the target recorded speech data and the changed character string for the change target character string.

3. The speech modification assistance apparatus according to claim 2, wherein
the generation control unit
generates the modified speech data obtained by synthesizing changed character string speech data of the changed character string with a change target speech segment corresponding to the change target character string in the target recorded speech data.

4. The speech modification assistance apparatus according to claim 2, wherein the hardware processors are configured to further function as:
an acquisition unit configured to acquire, as teaching recorded speech data, an uttered speech of a user corresponding to an output target character string obtained by converting the change target character string included in the basic character string into the changed character string, wherein
the generation control unit
generates the modified speech data obtained by synthesizing changed recorded speech data corresponding to the changed character string in the teaching recorded speech data with a change target speech segment corresponding to the change target character string in the target recorded speech data.

5. The speech modification assistance apparatus according to claim 4, wherein
the generation control unit
adjusts a pitch of a speech represented by the changed recorded speech data to a pitch of a speech in the change target speech segment in the target recorded speech data,
reflects prosody of the change target speech segment in the target recorded speech data to the changed recorded speech data for which the pitch of the speech is converted, and
generates the modified speech data obtained by synthesizing the changed recorded speech data to which the prosody is reflected with the change target speech segment in the target recorded speech data.

6. The speech modification assistance apparatus according to claim 2, wherein the hardware processors are configured to further function as:
a fourth reception unit configured to receive an input of setting change information of at least one of an acoustic feature amount of a speech of the changed character string and a synthesis method, wherein
the generation control unit
adjusts an acoustic feature amount of speech data in a speech segment of the changed character string to the acoustic feature amount included in the setting change information, and
generates the modified speech data obtained by synthesizing the speech data for which the acoustic feature amount is adjusted with a change target speech segment corresponding to the change target character string in the target recorded speech data according to the synthesis method included in the setting change information.

7. The speech modification assistance apparatus according to claim 2, wherein the hardware processors are configured to further function as:
a fifth reception unit configured to receive an input of detailed edit information of at least one of an acoustic feature amount of a speech of the changed character string and a synthesis method, wherein
the generation control unit
adjusts an acoustic feature amount of speech data in a speech segment of the changed character string to the acoustic feature amount included in the detailed edit information, and
generates the modified speech data obtained by synthesizing the speech data for which the acoustic feature amount is adjusted with a change target speech segment corresponding to the change target character string in the target recorded speech data according to the synthesis method included in the detailed edit information.

8. The speech modification assistance apparatus according to claim 1, wherein the hardware processors are configured to further function as:
a sixth reception unit configured to receive a reproduction instruction for the modified speech data; and
a reproduction control unit configured to reproduce the modified speech data.

9. A speech modification assistance method implemented by a computer, the method comprising:
receiving selection of target recorded speech data, which is basic recorded speech data to be processed, from among one or more pieces of basic recorded speech data that are recorded;
converting the target recorded speech data into a basic character string and display the basic character string;
receiving designation of a change target character string to be changed in the displayed basic character string; and
generating modified speech data corresponding to the target recorded speech data and the change target character string.

10. A speech modification assistance computer program product having a non-transitory computer readable medium including programmed instructions stored thereon, wherein the instructions, when executed by a computer, cause the computer to execute:
receiving selection of target recorded speech data, which is basic recorded speech data to be processed, from among one or more pieces of basic recorded speech data that are recorded;
converting the target recorded speech data into a basic character string and display the basic character string;
receiving designation of a change target character string to be changed in the displayed basic character string; and
generating modified speech data corresponding to the target recorded speech data and the change target character string.

11. A speech modification assistance system comprising:
a speech modification assistance apparatus; and
an information processing apparatus, wherein
the speech modification assistance apparatus comprises:
one or more first hardware processors configured to function as:
a first reception unit configured to receive selection of target recorded speech data, which is basic recorded speech data to be processed, from among one or more pieces of basic recorded speech data that are recorded;
a display control unit configured to convert the target recorded speech data into a basic character string and display the basic character string;
a second reception unit configured to receive designation of a change target character string to be changed in the displayed basic character string;
a generation control unit configured to generate modified speech data corresponding to the target recorded speech data and the change target character string; and
a storing processing unit configured to store modification-related information regarding modification of the modified speech data, and
the information processing apparatus comprises:
one or more second hardware processors configured to function as:
a reception unit configured to receive the modification-related information; and
a modification processing unit configured to generate modified speech data obtained by modifying the target recorded speech data based on the modification-related information.
